(19) United States
(12) Patent Application Publication
(10) Pub. No.: US 2012/0173270 A1
(43) Pub. Date: Jul. 5, 2012

(54) Automated Creation and Maintenance of Nutritional Regimen for Obesity Patients After Surgical Procedures

(76) Inventor: Julian Omidi, Las Vegas, NV (US)

(21) Appl. No.: 13/341,927

(22) Filed: Dec. 31, 2011

Related U.S. Application Data
(60) Provisional application No. 61/429,019, filed on Dec. 31, 2010.

(51) Int. Cl. G06Q 50/22

(52) U.S. Cl. 705/2

(57) ABSTRACT

The present invention is comprised of an interactive outpatient internet based network for providing automated outpatient medical follow up and support services. The present invention is further comprised of automated interactive customized modules to provide medical personnel with daily reports on outpatient treatment progress and condition. The present invention is further comprised of modules that create a cost effective interactive connection between an outpatient and medical staff where distance and lack of contact can place an outpatient at greater risk of relapse and prevent medical personnel from performing desired follow up services.

### SUMMARY

The present invention is embodied in an automated system and method of creation and maintenance of a nutritional regimen for obesity patients after surgical procedures are performed, such as laparoscopic gastric banding.

### BRIEF DESCRIPTION OF THE DRAWINGS

FIG. 1 shows a block diagram of an overview of an interactive outpatient internet based network of one embodiment of the present invention.

FIG. 2 shows a block diagram of an overview flow chart of an interactive outpatient internet based network of one embodiment of the present invention.

FIG. 3 shows a block diagram of an overview flow chart of automated scheduling, reminder and alert modules of one embodiment of the present invention.

FIG. 4A shows a block diagram of an overview flow chart of an automated daily food intake module of one embodiment of the present invention.

FIG. 4B shows a block diagram of an overview flow chart of a dietary and nutrition resource module of one embodiment of the present invention.

FIG. 5 shows a block diagram of an overview flow chart of an outpatient virtual examine room module of one embodiment of the present invention.

FIG. 6 shows a block diagram of an overview flow chart of an automated outpatient progress reporting module of one embodiment of the present invention.

FIG. 7 shows a block diagram of an overview flow chart of an outpatient meal delivery system of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of an interactive outpatient Internet based network is described for illustrative purposes and the underlying system can apply to all types of outpatient categories and health care centers. In one embodiment of the present invention, the interactive outpatient internet based network may include customized modules and capabilities to provide interactive service to obese weigh loss outpatients. The interactive outpatient internet based network can be configured to include modules and capabilities to service cardiac outpatients and can be configured to provide medical monitoring of patient treatment progress and inform medical staff of changes in outpatient conditions using the present invention.

The present invention provides a reconnection between an outpatient and medical staff. The outpatient can communicate easily to get answers to questions, report on a daily basis their activities and adherence to post treatment regimen, receive feedback on their progress and get guidance on their efforts to maintain dietary and other treatment activities. Medical staff can be automatically apprised of outpatient conditions and alerted when progress falls short. The automated features of the present invention provide medical personnel the freedom of time to attend other patients and still maintain daily oversight of an outpatient condition and progress. The outpatient is less likely to become depressed or anxious about being cut lose from the daily hospital attention and care giving. The outpatient can remained connected on a daily basis to the medical care system and guidance rather than count the calendar days until the next scheduled office visit of one embodiment of the present invention.

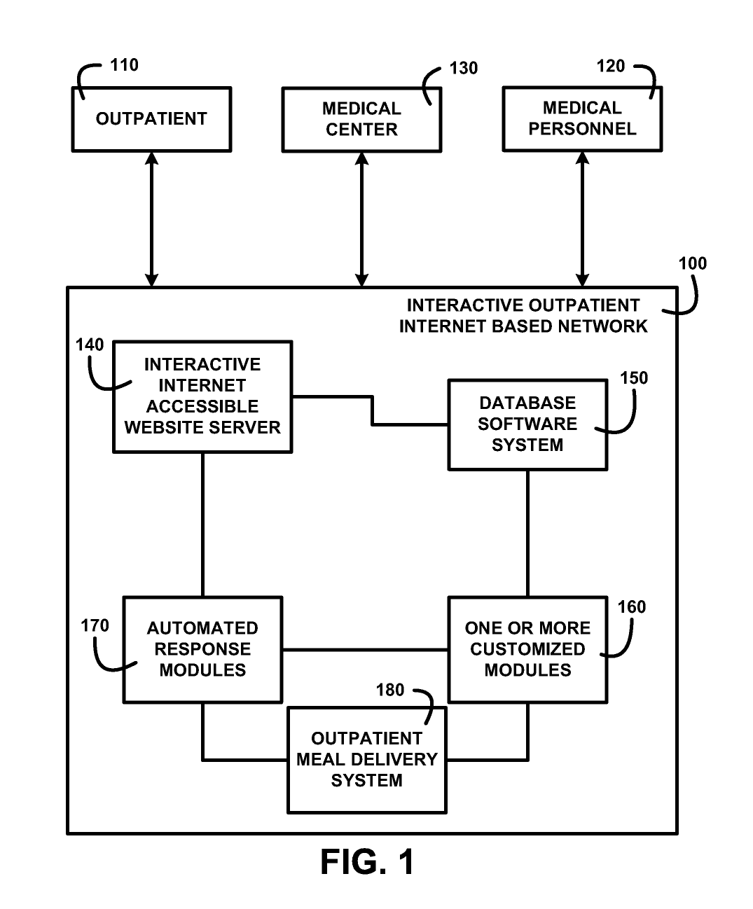

FIG. 1 shows a block diagram of an overview of an interactive outpatient internet based network of one embodiment of the present invention. FIG. 1 shows an interactive outpatient internet based network 100 for managing the daily diet and wellness condition of outpatients to provide the patient with support services and allow physicians to monitor the patient daily regimen and progress. The interactive outpatient internet based network 100 is configured to allow one or more outpatient 110, medical personnel 120 and a medical center 130 to maintain daily contact of one embodiment of the present invention.

The interactive outpatient internet based network 100 can be configured to use an interactive internet accessible website server 140 to provide an electronic connection between the outpatient 110 and medical personnel 120. The outpatient 110 is able to report their activities relating to the prescribed medical regimen provided by the medical center 130. The outpatient 110 reporting is inputted through the interactive internet accessible website server 140 and recorded in a database software system 150. The database software system 150 is configured with one or more customized modules 160 to add outpatient 110 activities input to their medical records of one embodiment of the present invention.

The customized modules 160 can be configured to automatically evaluate the data received from the outpatient 110. The customized modules 160 can be configured for example to evaluate outpatient 110 reported food intake to compare daily intake with dietary goals. The customized modules 160 can be configured to for example to automatically predict possible patient progress based on reported activities. The customized modules 160 can be configured to generate messages to an outpatient using automated response modules 170 of one embodiment of the present invention.

The customized modules 160 can be configured to automatically for example search the database software system 150 and retrieve food alternatives that are lower in salt content when the automated evaluation indicates higher than desired sodium levels. The automated response modules 170 can be configured to for example automatically compose and send an email message to the outpatient 110 alerting them of the increased sodium level and send information for the food alternatives that are lower in salt content. The automated response modules 170 can be configured for example to send a copy of the email message to medical personnel 120 to alert them of the higher sodium levels and better monitor the patients condition on a daily basis while the outpatient 110 is out of a medical center 130 or hospital setting. The medical personnel 120 can reply to the automated message and send additional instructions and guidance to the outpatient 110. The message including any replies is logged into the outpatient 110 medical records of one embodiment of the present invention.

The interactive outpatient internet based network 100 can be accessed by the outpatient from home and while traveling great distances from the medical center 130. The interactive outpatient internet based network 100 provides updates on outpatient 110 activities, direct and automated interaction between patient and medical staff, automated evaluations and automatically maintaining accurate and daily patient progress and conditions. The interactive outpatient internet based network 100 creates a cost effective, convenient and more comprehensive program for managing outpatient 110 health care and keeping an outpatient connected to their health care professional of one embodiment of the present invention.

### Detailed Operation:

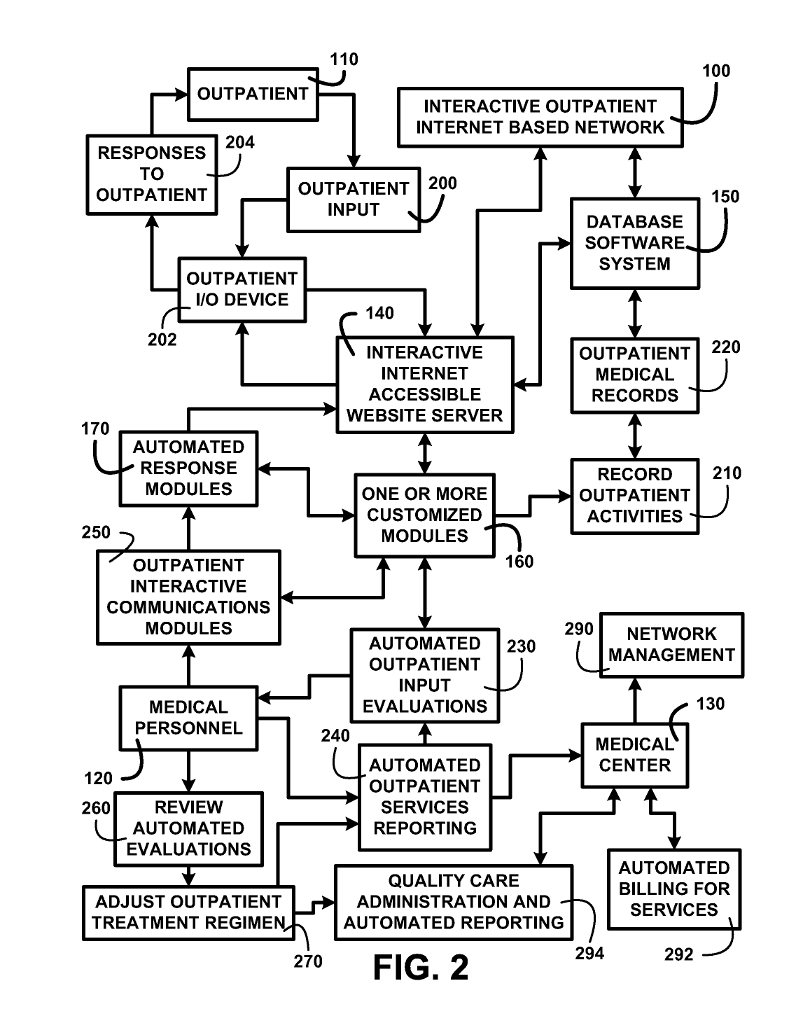

FIG. 2 shows a block diagram of an overview flow chart of an interactive outpatient internet based network of one embodiment of the present invention. FIG. 2 shows the interactive outpatient internet based network 100 providing a treatment connection between the outpatient 110 and their health care professionals. The outpatient 110 can log into the interactive outpatient internet based network 100 through the interactive internet accessible website server 140. The outpatient 110 can provide outpatient input 200 involving their treatment progress, questions, physical, emotional and mental conditions and report activities. The outpatient 110 can use an outpatient I/O device 202 to connect to the network. The outpatient I/O device 202 can be any electronic device such as a computer, iphone, ipad, smart phone, and other digital devices of one embodiment of the present invention.

The interactive internet accessible website server 140 can be configured to connect to the database software system 150 to use one or more customized modules 160 to for example record outpatient activities 210 in outpatient medical records 220. The interactive outpatient internet based network 100 uses one or more customized modules 160 for example the automated response modules 170 to generate automated responses to outpatient 204 input issues. The outpatient I/O device 202 can be used to connect to various outpatient interactive communications modules 250. The outpatient interactive communications modules 250 can be configured to provide text, voice and video communications between the outpatient 110, the medical personnel 120 and the medical center 130 of one embodiment of the present invention.

The one or more customized modules 160 can be configured to perform automated outpatient input evaluations 230 and report those evaluations to the medical personnel 120. The medical personnel 120 can review automated evaluations 260 to determine whether to adjust outpatient treatment regimen 270. The one or more customized modules 160 records the medical personnel 120 services and performs automated outpatient services reporting 230. The automated outpatient services reporting 230 is transmitted to the medical center 130 to be used in quality care administration and automated reporting 294 of agency tracking criteria. The medical center 130 uses one or more customized modules 160 to perform network management 290 services and process automated billing for services 292 of one embodiment of the present invention.

The interactive outpatient internet based network 100 uses one or more customized modules 160 to track outpatient progress on a daily basis. The interactive outpatient internet based network 100 provides the outpatient 110 with a daily connection to the medical center 130 and medical personnel 120 to enhance their treatment results and relieve anxiety commonly felt when facing the treatment regimen alone of one embodiment of the present invention.

### Automated Scheduling, Reminder and Alert Modules:

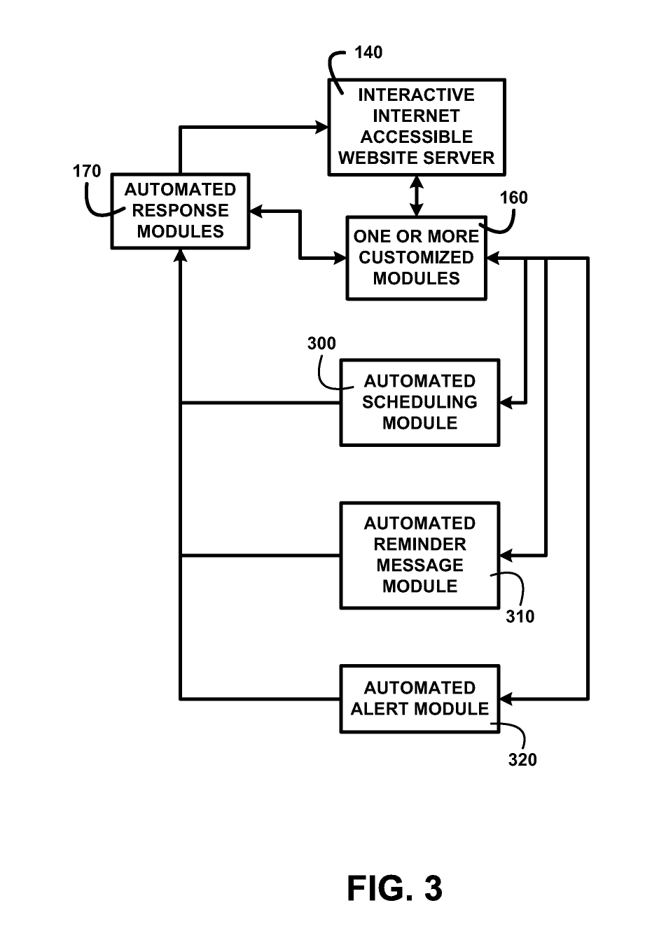

FIG. 3 shows a block diagram of an overview flow chart of automated scheduling, reminder and alert modules of one embodiment of the present invention. FIG. 3 shows the interactive internet accessible website server 140 using one or more customized modules 160 configured to record, automatically schedule and report task completion notices using the automated response modules 170 using the outpatient interactive communications modules 250 of FIG. 2. One or more customized modules 160 can be configured for example as an automated scheduling module 300. The automated scheduling module 300 can be configured to create for example periodic appointments using the coordinated to the schedules of medical personnel 120 of FIG. 1 and the outpatient 110 of FIG. 1 to discuss treatment progress. The medical personnel 120 of FIG. 1 can record desired dates and times to perform follow-up communications of one embodiment of the present invention.

One or more customized modules 160 can be configured for example as an automated reminder message module 310 to alert an outpatient 110 of FIG. 1 for example to take medications, control sodium intake, complete prescribed regimen, report immediately any deteriorating or worsening conditions and negative symptoms from medications, foods or activities and remind them of office appointments. The automated reminder message module 310 can be configured to send appointment reminders to the medical personnel 120 of FIG. 1. The automated reminder message module 310 can be configured to include automatic email messages for example that list preoperative do's and don'ts for an outpatient 110 of FIG. 1 and an automatic outpatient 110 of FIG. 1 check off reply reporting compliance or noncompliance which could generate an automatic alert to medical personnel 120 of FIG. 1 that the procedure might be postponed or rescheduled. The automated reminder message module 310 provides services to both the outpatient 110 of FIG. 1 and medical personnel 120 of FIG. 1 keeping the outpatient 110 of FIG. 1 treatment process on track. The system of claim 1, wherein the automated reminder message module can be configured to include automatic email messages for example that list preoperative do's and don'ts for an outpatient and an automatic outpatient check off reply reporting compliance or noncompliance which could generate an automatic alert to medical personnel that the procedure might be postponed or rescheduled track of one embodiment of the present invention.

One or more customized modules 160 can be configured for example as an automated alert module 320 to send automated messages to medical personnel such as report a lack of web based interaction by an outpatient. The automated alert module 320 can be configured to report negative progress on the outpatient 110 of FIG. 1 to medical personnel 120 of FIG. 1 to advise them to make contact with the outpatient 110 of FIG. 1 to determine reasons for no interaction and confirm condition of the outpatient 110 of FIG. 1. The automated alert module 320 can be configured to send automated messages to an outpatient 110 of FIG. 1 such as they have reached the limitation set on salt intake or that they did not report taking a medication of one embodiment of the present invention.

### Automated Daily Food Intake Module:

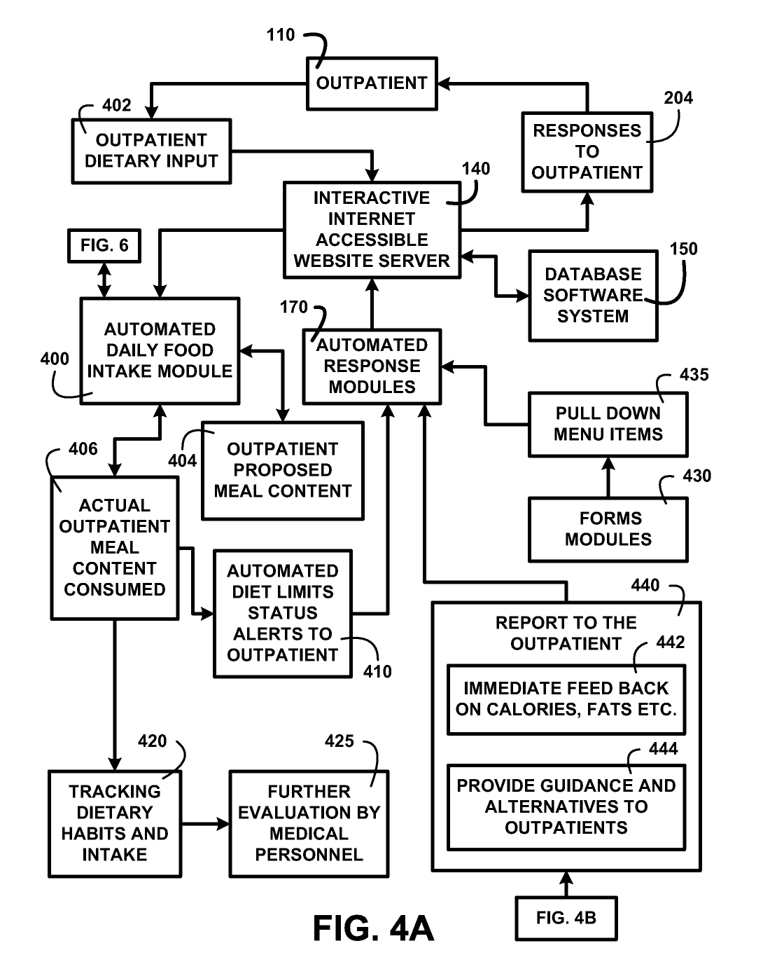

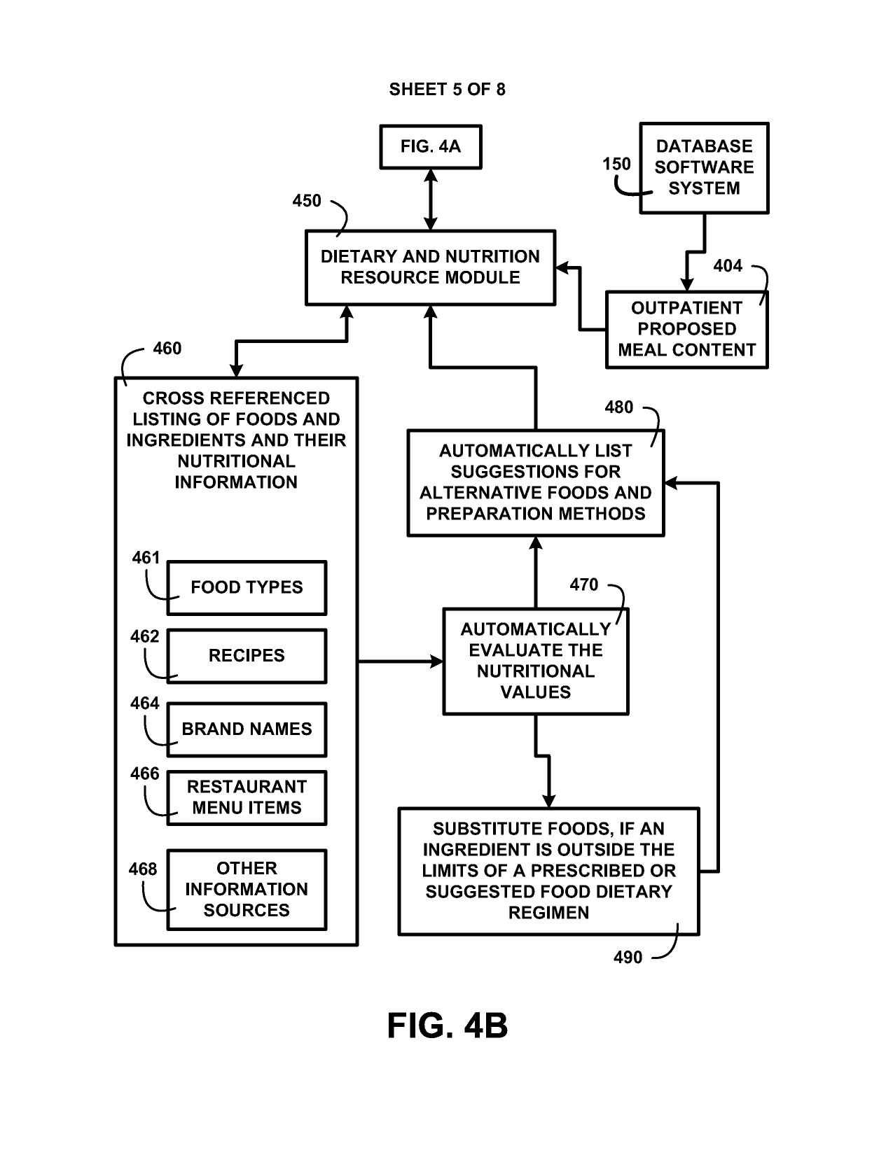

FIG. 4A shows a block diagram of an overview flow chart of an automated daily food intake module of one embodiment of the present invention. The diet of an outpatient 110 can have significant impacts on their recovery or ongoing treatment. Different classifications of patients when released from hospital care for example obese weight loss and cardiac outpatients must maintain a strict dietary regimen to effect beneficial treatment results. This can be very difficult when facing each day alone without others to offer encouragement and remind the outpatient 110 of the importance to adhere to the diet. Some outpatients simply do not have the culinary skills or knowledge to determine whether they are straying. The interactive outpatient internet based network 100 of FIG. 1 provides the outpatient 110 with the support on a daily basis to remain on track and provide the knowledge base to better enable them to evaluate and stay faithful to this vital element of their treatment of one embodiment of the present invention.

FIG. 4A shows the outpatient 110 accessing the interactive internet accessible website server 140 to enter outpatient dietary input 402 daily for each meal. The outpatient dietary input 402 is record in the database software system 150. The database software system 150 provides the outpatient 110 with pull down menu items 435 from various forms modules 430 to make it easier for the outpatient 110 to enter outpatient dietary input 402. The database software system 150 automatically sends the outpatient dietary input 402 to an automated daily food intake module 400. The automated daily food intake module 400 proceeds to record outpatient proposed meal content 404 for further processing as described in FIG. 4B of one embodiment of the present invention.

The automated daily food intake module 400 upon receipt of additional outpatient 110 input proceeds to record actual outpatient meal content consumed 406. The automated daily food intake module 400 can be configured to provide automated diet limits status alerts to outpatient 410. For example a cardiac outpatient 110 must keep close watch on their salt and sodium intake. The automated daily food intake module 400 can be configured to keep totals on the dietary intake to allow tracking dietary habits and intake 420 for each outpatient 110. The tracking dietary habits and intake 420 allows further evaluation by medical personnel 425 to more closely monitor an outpatient 110 condition on a daily basis of one embodiment of the present invention.

The automated daily food intake module 400 can be configured to further process the results of the processing described in FIG. 4B for example automatically generate a report to the outpatient 440 to provide immediate feed back on calories, fats etc. 442 determined from the outpatient proposed meal content 404. The automated daily food intake module 400 can be configured to provide additional reports to provide guidance and alternatives to outpatients 444. The reports are transmitted to the outpatient 110 through the automated response modules 170. The interactive nature of the automated daily food intake module 400 provides the outpatient 110 with the support to maintain adherence to the dietary regimen of one embodiment of the present invention.

### Dietary and Nutrition Resource Module:

FIG. 4B shows a block diagram of an overview flow chart of a dietary and nutrition resource module of one embodiment of the present invention. FIG. 4B shows a process continuing from FIG. 4A wherein the interactive outpatient internet based network 100 of FIG. 1 can be configured to include a dietary and nutrition resource module 450. The dietary and nutrition resource module 450 can be configured to perform automated evaluation of the outpatient proposed meal content 404 that is transmitted from the database software system 150. The dietary and nutrition resource module 450 can be configured as a cross referenced listing of foods and ingredients and their nutritional information 460. The cross referenced listing of foods and ingredients and their nutritional information 460 can for example include various food types 461, recipes 462 and their ingredients, prepared foods identifiable by the commercial brand names 464, restaurant menu items 466 from regional eateries and other information sources 468 related to nutritional information of one embodiment of the present invention.

The dietary and nutrition resource module 450 can be configured to automatically evaluate the nutritional values 470 of the outpatient proposed meal content 404. The dietary and nutrition resource module 450 can be configured to automatically list suggestions for alternative foods and preparation methods 480 to inform the outpatient 110 of FIG. 1. The dietary and nutrition resource module 450 can be configured to suggest substitute foods, if an ingredient is outside the limits of a prescribed or suggested food dietary regimen 490. The dietary and nutrition resource module 450 can be configured to automatically transmit the outpatient proposed meal content 404 nutritional evaluation and any food or preparation alternatives to the automated daily food intake module 400 of FIG. 4A for further processing to relay the information to the outpatient 110 of FIG. 1 to adjust the meal ingredients if advisable to allow the outpatient to better adhere to the prescribed dietary regimen of one embodiment of the present invention.

### Outpatient Virtual Examine Room Module:

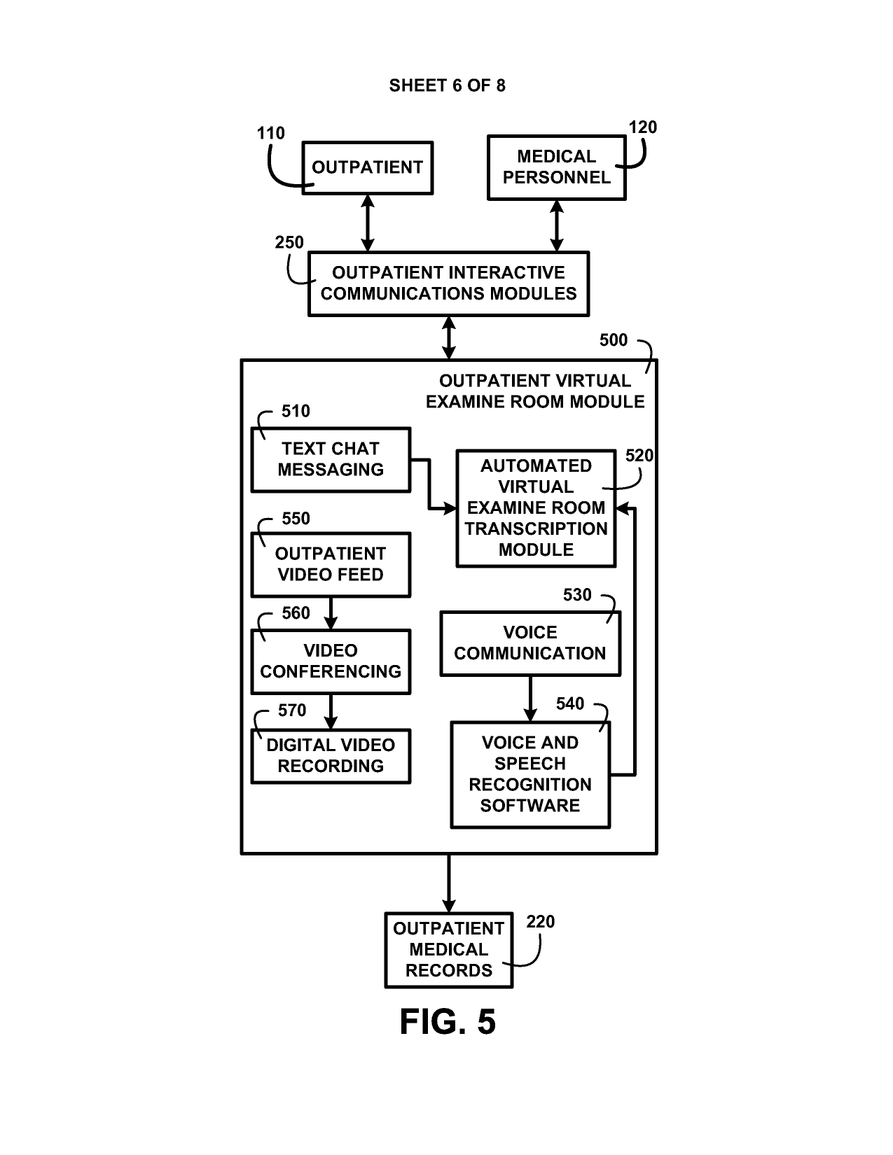

FIG. 5 shows a block diagram of an overview flow chart of an outpatient virtual examine room module of one embodiment of the present invention. FIG. 5 shows a convenient, low cost effective method to conduct an out of the office consultation between the outpatient 110 and medical personnel 120. The interactive outpatient internet based network 100 of FIG. 1 can be configured to include outpatient interactive communications modules 250. The outpatient interactive communications modules 250 can be configured to create an outpatient virtual examine room module 500. The outpatient virtual examine room module 500 can be configured to allow two way text and verbal communication between the outpatient 110 and medical personnel 120 to discuss the patient progress and condition of one embodiment of the present invention.

The outpatient virtual examine room module 500 can be configured to include text chat messaging 510. The outpatient virtual examine room module 500 can be configured to include an automated virtual examine room transcription module 520 to record online text messages in a dialogue format. The outpatient virtual examine room module 500 can be configured to include voice communication 530 between the outpatient 110 and medical personnel 120 wherein voice and speech recognition software 540 can allow the automated virtual examine room transcription module 520 to transcribe and record the conversation of one embodiment of the present invention.

The outpatient virtual examine room module 500 can be configured to include video conferencing 560 between the outpatient 110 and medical personnel 120. The outpatient 110 can use a webcam to produce an outpatient video feed 550 to enable the video conferencing 560. The video conferencing 560 sessions can be processed into a digital video recording 570 that can be stored in the outpatient medical records 220 of FIG. 2. The outpatient virtual examine room module 500 video conferencing 560 feature allows the outpatient 110 and medical personnel 120 to physically see one another. This adds great value to the capability of the outpatient virtual examine room module 500. During a video conferencing 560 consultation and examination for example when indicated to evaluate visible sores that have developed, skin conditions or other difficult to assess conditions. The medical personnel 120 can better evaluate the severity of the condition and ask the outpatient 110 to immediately come to the medical office or seek emergency room care of one embodiment of the present invention.

The interactive outpatient Internet based network 100 including the outpatient virtual examine room module 500 provides a comprehensive outpatient 110 follow-up program by medical personnel 120. The outpatient 110 is able to stay connected to the medical services that otherwise would not be available. The medical personnel 120 can fulfill their desire and duty to monitor the outpatient 110 progress and condition with a frequency that otherwise would not be available. The medical center 130 of FIG. 1 can provide comprehensive and efficient quality outpatient health care at lower costs that otherwise would not be available. The interactive outpatient internet based network 100 fills the void that exists currently with cost effective automated outpatient patient tracking of one embodiment of the present invention.

### Automated Outpatient Progress Reporting Module:

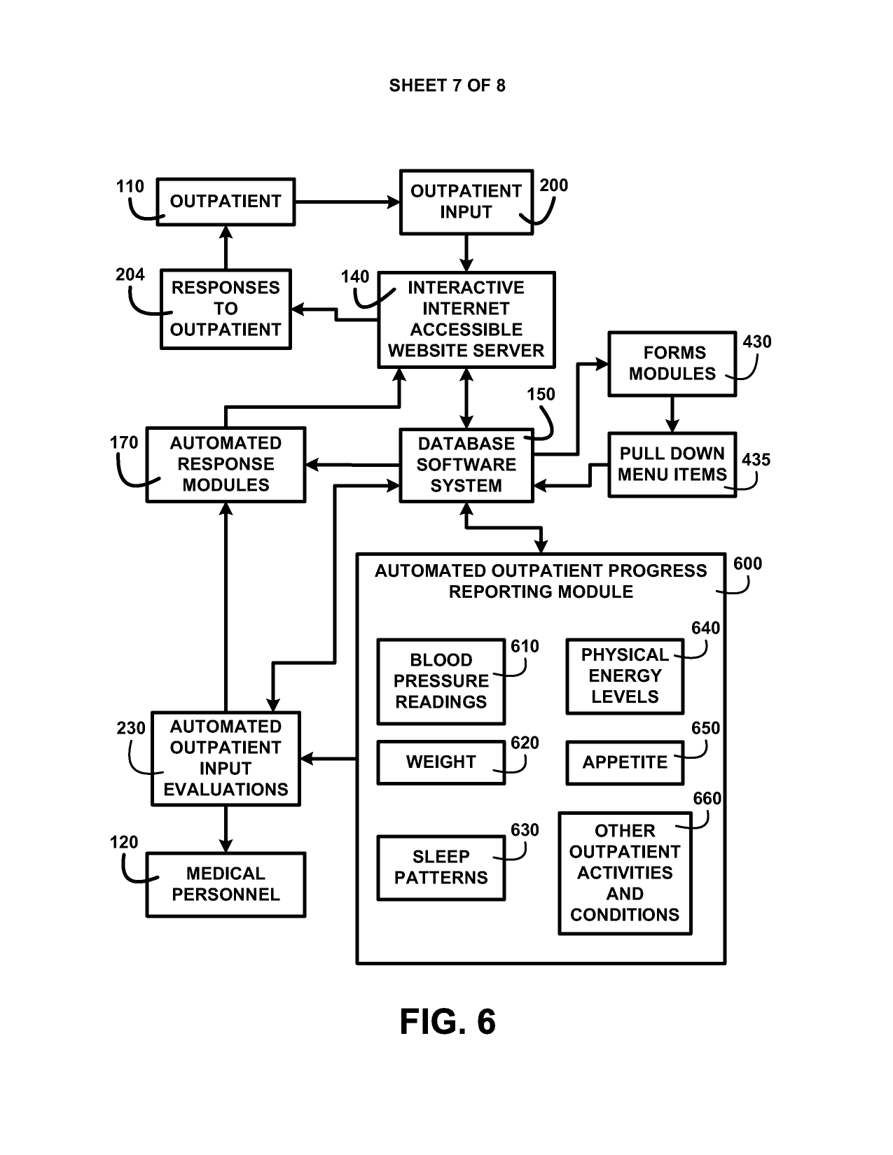

FIG. 6 shows a block diagram of an overview flow chart of an automated outpatient progress reporting module of one embodiment of the present invention. FIG. 6 shows the outpatient 110 entering outpatient input 200 through the interactive Internet accessible website server 140 to report self administered test and self assessment of their condition. The outpatient 110 can call up an automated outpatient progress reporting module 600 to enter the results of the self administered test and give their own assessment of their conditions. The automated outpatient progress reporting module 600 automatically queries database software system 150 to select from the forms modules 430 to display one or more of the pull down menu items 435 of one embodiment of the present invention.

The outpatient 110 enters the self administered test results into the proper blank of the pull down menu items 435. The self administered test results can include for example blood pressure readings 610, pulse and weight 620. The outpatient 110 enters into the pull down menu items 435 their own assessment of their conditions for example sleep patterns 630, physical energy levels 640, appetite 650 and other outpatient activities and conditions 660. The automated outpatient progress reporting module 600 performs automated outpatient input evaluations 230 using the newest outpatient input 200 and past data stored on the database. The automated outpatient progress reporting module 600 automatically prepares progress reports to send to medical personnel 120 to review. The automated outpatient progress reporting module 600 also processes the progress reports including graphical results charts to the automated response modules 170 to generate immediate feedback responses to outpatient 204 of one embodiment of the present invention.

The automated outpatient progress reporting module 600 standardizes the input format of self administered test and self assessments by the outpatient 110. The ability of the outpatient 110 to accurately provide this progress information on a daily basis allows medical personnel 120 to better evaluate the outpatient 110 condition. The medical personnel 120 can make informed timely adjustments in the outpatient 110 treatment regimen of one embodiment of the present invention.

### Outpatient Meal Delivery System:

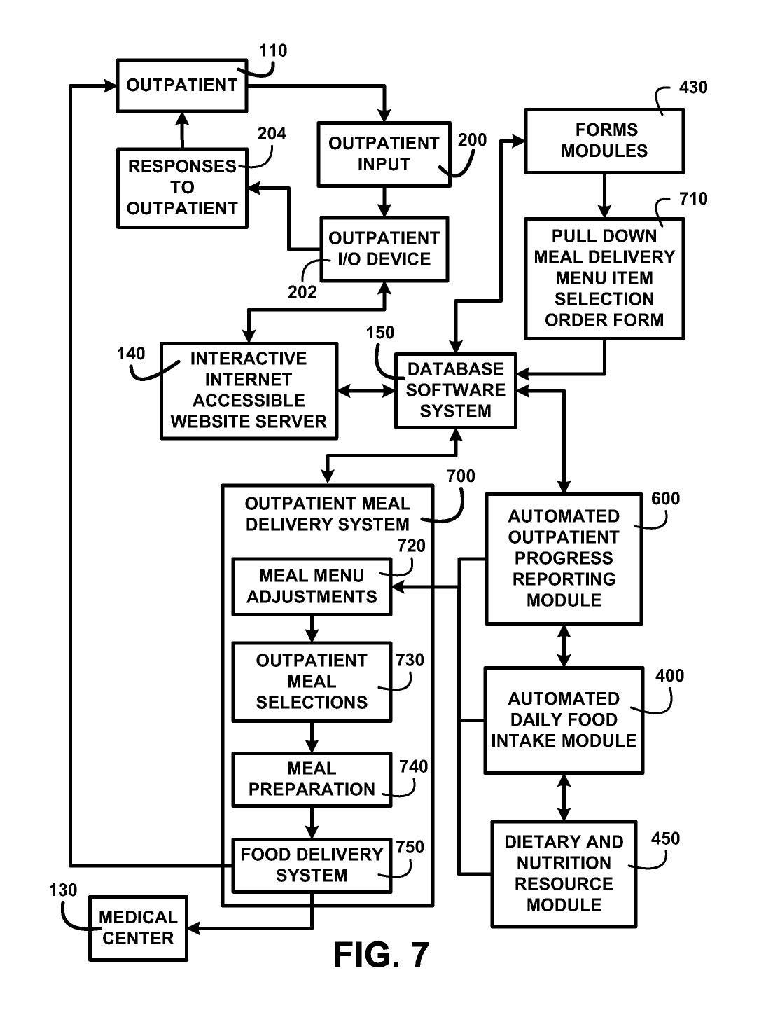

FIG. 7 shows a block diagram of an overview flow chart of an outpatient meal delivery system of one embodiment of the present invention. The interactive outpatient Internet based network 100 of FIG. 1 forms a support network for the outpatient 110 to keep them connected to the health care providers. This support network extends that support for an outpatient 110 who may not have the desire to or be able to cook and prepare their own meals for example reduced mobility, poor eye sight or just a lack of cooking ability.

FIG. 7 shows an outpatient meal delivery system 700 wherein an outpatient 110 can enter outpatient input 200 through their outpatient I/O device 202 to the interactive internet accessible website server 140. The outpatient meal delivery system 700 automatically loads a pull down meal delivery menu item selection order form 710 from the forms modules 430. The outpatient 110 makes selections from the meals, including drinks and snacks, listed on the menu and can submit the order. The outpatient meal delivery system 700 automatically generates the order and reports that for meal preparation 740 and the food delivery system 750 to get the prepared meals delivered to the outpatient 110 residence. The outpatient meal delivery system 700 automatically generates the billing for the meal order and processes that to the medical center 130 of one embodiment of the present invention.

The outpatient meal delivery system 700 automatically receives evaluation reports from the automated daily food intake module 400, dietary and nutrition resource module 450 and automated outpatient progress reporting module 600. The outpatient meal delivery system 700 automatically uses the evaluations to make meal menu adjustments 720. The meal menu adjustments 720 can for example change ingredients and portions to increase calories if weight loss is too rapid, reduce calories if weight loss is to slow, reduce salt and sodium if blood pressure is rising and reduce carbohydrates if the outpatient 110 reports trouble falling asleep. The meal menu adjustments 720 are incorporated into an adjusted pull down meal delivery menu item selection order form 710 from which the outpatient meal selections 730 are made. The outpatient meal delivery system 700 and adjustments to the menu will improve the outpatient 110 progress and assist them to maintain a prescribed dietary regimen of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. An interactive outpatient internet based network and automated system and method of creation and maintenance of a nutritional regimen for obesity patients after surgical procedures are performed, such as laparoscopic gastric banding.
